(19) United States
(12) Patent Application Publication
(10) Pub. No.: US 2025/0209314 A1
(43) Pub. Date: Jun. 26, 2025

(54) Systems and Methods to Accelerate Neural Network Computations in Heterogenous Computing Systems

(71) Applicant: Advanced Micro Devices, Inc., Santa Clara, CA (US)

(72) Inventors: Eashan Dash, Bangalore (IN); Arun Coimbatore Ramachandran, Bangalore (IN); Chandra Kumar Ramasamy, Bangalore (IN); Ganesh Prasad Nagaraja, Bangalore (IN); Phani Shankar Madineni, Bangalore (IN); Prakash Sathyanath Raghavendra, Bangalore (IN)

(21) Appl. No.: 18/395,488

(22) Filed: Dec. 23, 2023

(51) Int. Cl. G06N 3/0495

(52) U.S. Cl. CPC G06N 3/0495

(57) ABSTRACT

Systems, methods, and apparatus for partial tensor correction are disclosed. During quantization, weight tensors can be corrected for quantization errors in order to increase accuracy that is otherwise degraded as a result of quantization. To correct errors, the weight tensor is partially corrected using a data-free, non-iterative, per-input channel level technique to achieve accuracy improvement while using lower precision. Further, sensitive channels prone to accuracy degradation due to quantization are identified. Based on this identification, parts of weight tensor is retained for CPU computation and remaining parts of the weight tensor are offloaded for accelerator computation. The proposed partial tensor retention scheme achieves efficient heterogenous DNN computations with improved performance and accuracy on heterogenous systems. Furthermore, combining the partial tensor correction and partial tensor retention techniques allows for achieving improved performance and accuracy in a heterogenous computing environment while using low precision computations.

### BACKGROUND

### Description of the Related Art

Neural networks have emerged as powerful tools for solving complex tasks across a wide range of domains, including image and speech recognition, natural language processing, autonomous robotics, and medical diagnostics. These artificial neural networks are composed of interconnected layers of artificial neurons and are capable of learning and extracting complex patterns from data. They have achieved remarkable success in achieving human-level or even superhuman performance in various applications.

However, the widespread adoption of neural networks in real-world applications has been hindered by significant computational demands. Training and inference with deep neural networks (DNNs), especially those with millions or even billions of parameters, can be computationally intensive, consuming significant time and energy resources. Several limitations in neural network acceleration have been identified. For example, with DNNs, issues pertaining to computational complexity, bandwidth management, energy consumption, accuracy degradation, and hardware heterogeneity may arise.

In view of the above, systems and methods for improved performance while maintaining accuracy for neural networks are desired.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 illustrates one example of a block diagram depicting partial tensor correction for a neural network.

FIGS. 4A and 4B illustrate exemplary block diagrams for partial tensor retention.

FIG. 5 illustrates an exemplary block diagram for partial tensor retention using partial tensor correction.

FIG. 6 illustrates an exemplary method for partial tensor correction.

FIG. 7 illustrates an exemplary method for partial tensor retention.

FIG. 8 illustrates an exemplary method for partial tensor correction with partial tensor retention.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for improving performance of neural network computations while maintaining accuracy and performance are described. In the following, weight tensor correction and sensitive channel retention for neural networks are described. Corrections to weight tensors are made to account for quantization errors. In this manner, degradation in accuracy due to quantization, is corrected. In one implementation, error correction factors are computed during quantization and weight tensors are partially corrected (i.e., only a portion of the weight tensor is corrected) based on the computed error correction factors, post training, during quantization of the pre-trained weight tensor. In another example, error correction factors are computed during quantization and weight tensors are partially corrected based on the computed error correction factors during training and/or retraining. In one example, when an error is corrected for a partial weight tensor instead of the complete weight tensor, a higher error correction factor is used. By making corrections to only a subset of the tensor, the output error may be reduced.

In some implementations, quantization can improve performance, however, by creating a significant reduction in accuracy. In order to manage accuracy degradation owing to quantization, in one implementation, parts of the weight tensor can be quantized differently than other parts, e.g., based on sensitivity to quantization for a given channel. For instance, parts of the weight tensor that correspond to channels that are sensitive to quantization, are retained in their original precision. Further, remaining parts of the tensor, e.g., corresponding to channels that are relatively less sensitive to quantization, are quantized to precision values that are relatively lower than their original precision values. Further, processing of parts of the weight tensor retained in their original precision can be allocated to a CPU, while remaining parts of the weight tensor can be processed by one or more accelerators. By retaining a subset of weight tensor at a precision relatively higher than other parts, both the CPU and the accelerators can be utilized for processing the network, in a heterogenous computing architecture. With the capabilities of accelerators integrated with that of the CPU, the proposed solution uses heterogenous compute, e.g., by way of performing compute operations in parallel on the CPU and the accelerators. This can improve model accuracy and add robustness to the end-to-end model performance.

In an implementation, when retaining parts of the weight tensor in their original precisions (e.g., floating point values) and quantizing remaining parts to a relatively lower precisions (e.g., integer values), partial tensor corrections can be applied to the parts of the weight tensor quantized to lower precisions. In one example, for channels to be executed at lower precisions (i.e., corresponding to parts of the weight tensor quantized to lower precisions) computations are performed using accelerators, and this can result in significant accuracy degradation. In one implementation, these parts of the weight tensor can be partially corrected to mitigate accuracy degradation, e.g., encountered due to weight tensor parts being quantized to relatively lower precisions. In one implementation, partially correcting quantized parts of the weight tensor and retaining other parts of the weight tensor in their original precision, can result in accuracy for the entire model being closer to accuracies observed in models with entire weight tensor retained in full precision. Further, performance of such models is closer to performance observed in models wherein the entire weight tensor is quantized to a reduced precision. These and other implementations are described hereinafter.

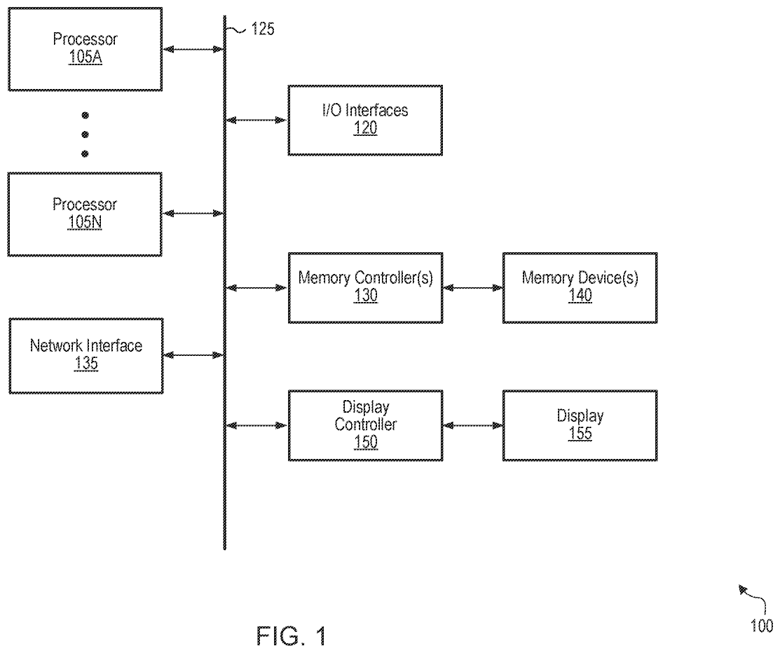

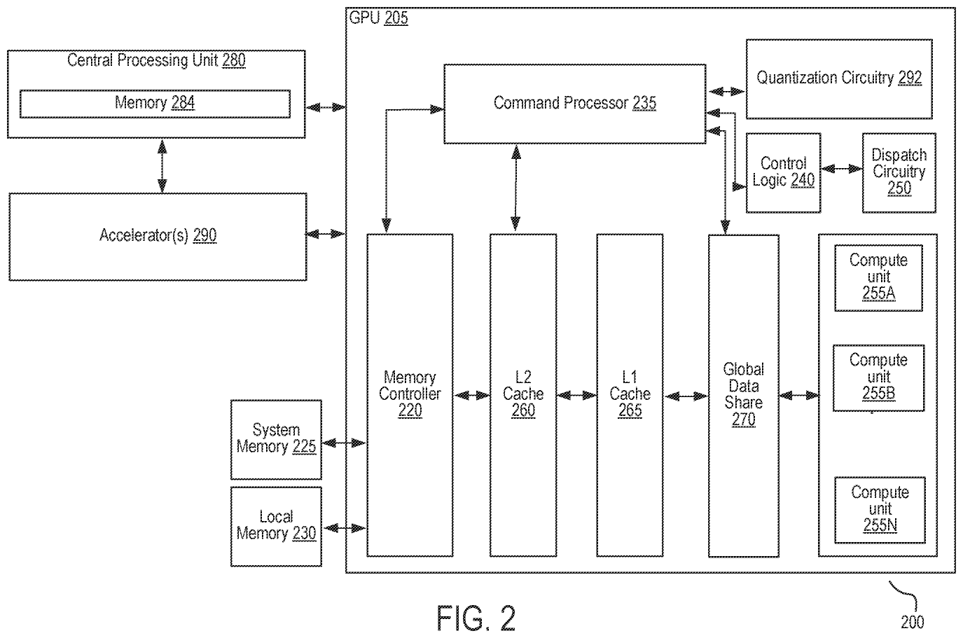

Referring now to FIG. 1, a block diagram of one implementation of a computing system 100 is shown. In an implementation, computing system 100 is configured to perform various functions, including executing neural networks. Neural networks are a fundamental component of many machine learning and artificial intelligence applications, including image recognition, natural language processing, and reinforcement learning applications. The computing system 100 is configured to quantize weight tensors associated with a neural network layer and compute quantization errors. These quantization errors are partially corrected for the weight tensor to improve accuracy and performance. Further, computing system 100 is configured to perform partial tensor retention, wherein channels sensitive to quantization error are retained in their original precisions while remaining channels can be quantized to a lower precision. These and other implementations are explained in detail with respect to subsequent FIGS. 2-8.

In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 2-8 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, server, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

As described hereinafter a “weight tensor” or simply “weight” or “tensor” refers to a collection of weights in a neural network organized into a multi-dimensional array or tensor. In deep learning, neural networks are often designed with multiple layers and multiple neurons within each layer. The weights for all connections between neurons form a weight tensor for that layer. The weight tensor is a key part of a model's parameters and is subject to optimization during training via techniques like gradient descent. The shape of the weight tensor depends on the architecture of the neural network. For example, in a deep neural network (DNN), weight tensors are 4-dimensional (height, width, input channels, output channels) to account for one or more operations.

In one or more implementations, “input channel” as used hereinafter refers to a different channel or feature map in the input data. Each input channel represents a specific aspect or feature of the data. For example, for a color input (RGB), the first layer will have 3 input channels, one each for red, green, and blue. Further, if there are 64 filters in the first layer, the output of this layer will have 64 channels which becomes the input for the second layer. Hence for the second layer, the number of input channels becomes 64. “Output channels” represents the number of filters present in a given layer of the DNN. For instance, if a layer has 32 filters, the weight tensor of that layer will have 32 output channels. The number of output channels in a layer is determined by the design of the neural network. Furthermore, “input channel level” and “output channel level” refer to the channel level at which data is processed.

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes quantization circuitry 292 and central processing unit (CPU) 280 at least including memory 284. Further, one or more accelerators 290 including, for example, a deep neural network processing unit (DPU) are depicted. Other implementations are contemplated. It is noted that while quantization circuitry is shown as part of GPU 205, this need not be the case. In other embodiments, the quantization circuitry 292 is external to the GPU 205. For example, in some implementations, the quantization circuitry is with CPU 280, Accelerator(s) 290, or otherwise.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N. As described below, certain types of circuits are referred to as “units” (e.g., a decode unit, compute unit, an arithmetic logic unit, functional unit, memory management unit, etc.). Accordingly, the term “unit” or “units” also refers to circuits or circuitry unless otherwise indicated.

In one implementation, quantization circuitry 292 is configured to quantize a neural network, e.g., a convolution neural network (CNN) or a deep neural network (DNN) in order to achieve one or more goals. For instance, in some implementations neural networks can be quantized to reduce memory footprint, lower computational resources required to process the neural network, and/or for energy efficiency of the system 200. In other implementations, the neural networks can also be quantized for privacy and security compliance or for hardware compatibility. In one implementation, the quantization of the neural network is performed by quantizing a weight tensor associated with each layer of the neural network. A given layer of the neural network may be made up of a plurality of input channels and a plurality of output channels. The weight tensor can represent the learnable parameters of the neural network and is used to perform weighted summations on input data during forward and backward passes. For instance, in a CNN, the weight tensor is associated with convolutional layers and fully connected (dense) layers. In a neural network, each weight tensor corresponds to a single layer in the network. These weight tensors contain filters or kernels that are used to extract features from the input data. For a given layer, the number of input channels of its weight tensor must match the number of channels in the input data or the output of the preceding layer. Further, the number of filters in the weight tensor determines the number of output channels in the layer's output feature map. Each filter processes the input channels and generates one channel in the output feature map, resulting in as many output channels as there are filters.

In an implementation, movement of data between the CPU 280 and accelerators 290 can create a huge overhead affecting the execution time for processing the network. To this end, quantization of the weight tensor can provide an efficient way to compress the neural network and thereby accelerate the execution of the network, e.g., by a given accelerator 290. However, quantization of weight tensors to accelerate processing of these networks can reduce accuracy. For instance, quantization error introduced during conversion of the neural network weight tensor from a higher precision to lower precision can reduce the overall accuracy of the network.

In one implementation, quantizing a weight tensor associated with a given layer of the neural network includes changing the precision of the weight tensor, e.g., from a higher precision floating-point format to a reduced precision Integerformat. Due to the reduction in precision, quantizing the weight tensor may introduce errors in computation. To correct for such errors, various approaches may be used. In some examples, weight correction can include retraining the neural network to correct and update the weights to reduce the quantization errors. Often the weight correction process with training and/or retraining is an iterative process during which the network's weights are adjusted. Such training and/or retraining may require additional training data. Various algorithms can be used to perform weight adjustment-like stochastic gradient descent (SGD) or one of its variants (e.g., Adam, RMSProp). Often the weight correction process is an iterative process during which the network's weights are adjusted to better fit the training data.

While the above discussed weight correction techniques can be used to address quantization errors, they are dependent on the availability of training and/or calibration data as they are data-driven and consume significant compute resources, are time consuming, and can impair overall system performance. In order to mitigate these issues, the quantization circuitry 292 is configured to implement a partial tensor correction method that involves correcting the weight tensor partially at an input channel level. In contrast to applying weight correction to the entire weight tensor, the quantization circuitry 292 corrects the error introduced by weight tensor quantization in a layer using a correction factor that is only applied to part of the weight tensor. Further, in various implementations, this weight correction is performed at an input-channel level as a data-free and non-iterative process.

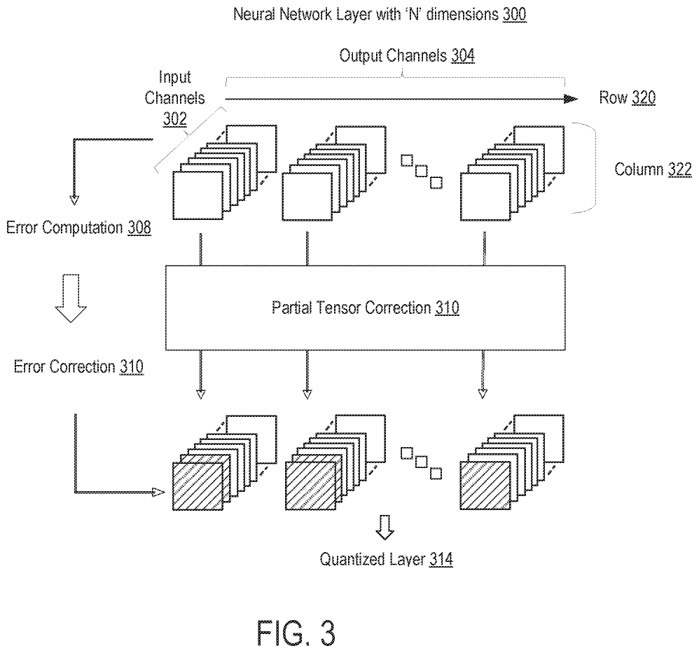

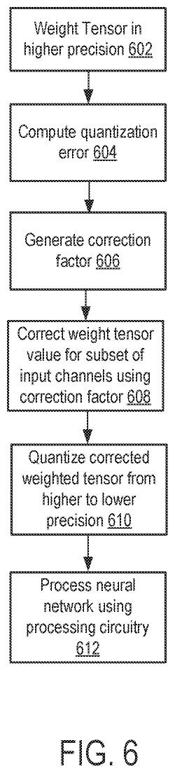

In one implementation, instead of correcting the weight tensor at each output channel level for a given layer of the neural network, the quantization circuitry 292 is configured to perform the partial weight tensor correction at an input channel level. For example, for each output channel, the quantization error is computed using errors introduced in each individual input channel. Using this computed quantization error, a correction factor is determined and weight tensor is corrected for a subset of input channels using the correction factor. In an implementation, the above correction is performed per output channel per layer. In one implementation, the correction factor is determined by dividing the quantization error by the total number of input channels. In an implementation, the quantization circuitry 292 is configured to perform partial weight tensor correction in which higher corrections are applied to partial weight tensors rather than smaller corrections being applied to complete weight tensors. The partial tensor weight correction is described in detail with regards to FIGS. 3 and 6.

In an implementation, the quantization circuitry 292 is configured to correct the weight tensor in a “data-free” and non-iterative manner. For example, when an error is introduced due to quantization based on a difference between dequantized and original weight tensor values, the quantization circuitry 292 is configured to approximate the quantization error in a manner that the error depends only on based on only the dequantized and original weight tensor values, and not on any input data values. This enables data-free error correction for the neural network layer. Because the approximation is done without requiring additional input, training, or other data, the approximation is said to be “data-free” or “input data-free.” Further, the approximated quantization error is corrected in a non-iterative (one time per layer) manner, thereby ensuring non-iterative error correction. In one example, the quantization error can result from the accelerator 290 using reduced precision weights for one or more Multiply Accumulate (MAC) operations performed at input channel levels. For example, to reduce the impact of numerical precision errors and save memory and computational resources, accelerator 290 can use reduced precision weights for performing MAC operations, thereby generating quantization noise or error. Other conditions that induce quantization errors are possible and are contemplated.

In some implementations, different processing circuitries have different capabilities for executing DNN models at varying precision levels. For instance, CPU 280 can only be capable of processing models at a different precision levels, e.g., precisions like FP32, and INT8 formats, whereas accelerator 290 can be capable of processing using lower precision (e.g., using INT-8 or INT-4 precision formats). In one implementation, the quantization circuitry 292 can retain weight tensors for output channels that are sensitive to quantization operation at either full precision or comparatively higher precisions and quantize weight tensors for the remaining output channels to a lower precision, such that the neural network can be processed using a combination of CPU 280 and accelerators 290 in a heterogenous manner. For instance, the higher precision output channels are queued for the CPU 280 for execution and the lower precision output channels are executed by the accelerators 290.

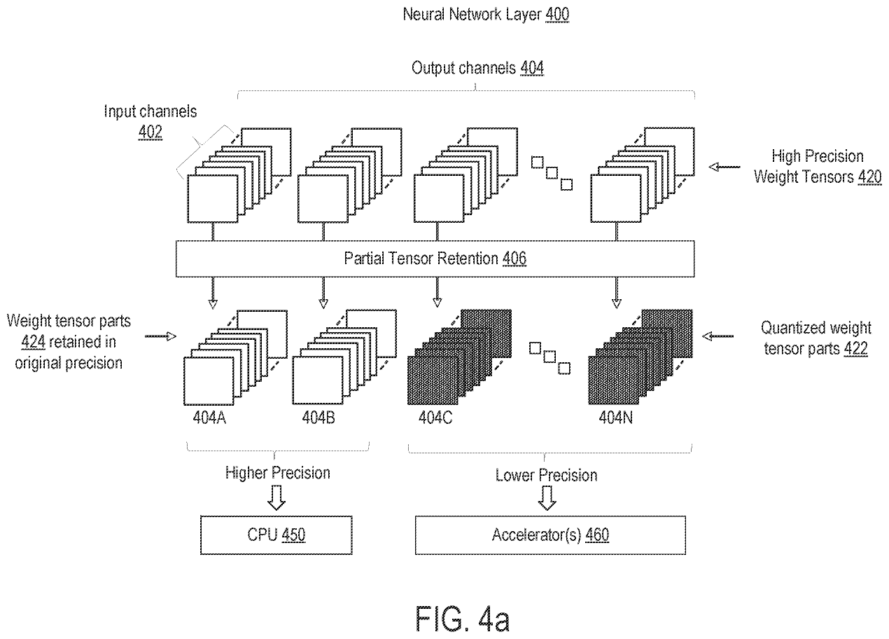

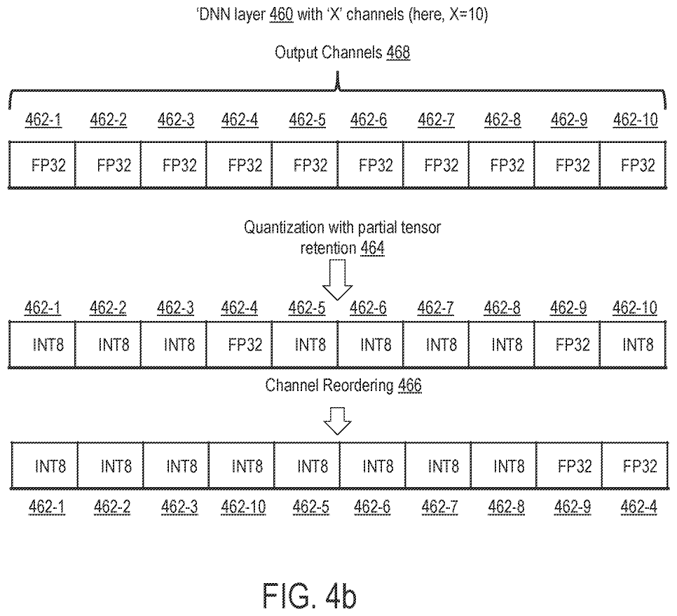

For instance, for 16 output channels in the given DNN layer, the quantization circuitry 292 can identify a number of output channels, e.g., 25 percent or 4 channels, that are sensitive to quantization errors. Traditional quantization schemes may quantize all the 16 output channels from FP32 to lower precisions like INT8 or INT4. However, since some channels are more sensitive to quantization errors than others, quantizing all channels may result in a greater loss of accuracy. To this end, the quantization circuitry 292 is configured to retain the sensitive output channels at higher precision and quantize only the remaining channels to lower precision. Further, higher precision channels are executed on the CPU 280, while lower precision filters are executed on one or more accelerators 290, thereby utilizing the heterogenous capabilities of the system 200. The partial tensor retention implementations are further detailed with regards to FIGS. 4, 5, and 8.

In one or more implementations, quantization circuitry 292, as described herein, includes specialized hardware for quantization of weight tensors involving operations such as weight tensor extraction, scaling, clipping, and rounding operations, specific to neural network weight tensors. In some implementations, the functionality of the quantization circuitry 292 as described herein is performed by software rather than hardware/circuitry. Further, in the implementation shown in FIG. 2, quantization circuitry 292 is shown as an internal part of the GPU 205, however in other implementations, quantization circuitry can also be a standalone processing circuitry in communication with the GPU 205, CPU 280, and accelerators 290. Such implementations are contemplated.

FIG. 3 an exemplary block diagram illustrating partial tensor correction for a neural network is described. As depicted, a neural network layer 300, comprising ‘N’ dimensions comprises of input channels 302 and output channels 304. In one implementation, the layer 300 is a fundamental building block of the network and is responsible for processing and transforming input data as it flows through the network. Each layer of the network includes a collection of neurons or units that perform specific computations on the input data and produce output values that are then passed to the next layer in the network. Further, the dimensions of the layer 300 are indicative of the size or shape of the layer's output, often called the “activation” or “feature map” of the layer 300. The dimensions of a layer are determined by several factors, including the layer's type, the size of its input, and the configuration of its parameters.

In the implementation described in the figure, the layer 300 is made up of 4 dimensions (i.e., N=4), that is, the input channels 302, the output channels 304, height of the layer 300 and width of the layer 300. In one implementation, “height” and “width” refer to the spatial dimensions of data, such as images or feature maps. These dimensions represent the size or shape of the data along two axes, usually corresponding to the vertical and horizontal directions. The “height” dimension represents the number of rows in a 2D matrix or array. In the context of images, it corresponds to the number of pixel rows from top to bottom. For example, in a grayscale image, if the height is 128 pixels, there are 128 rows of pixels from the top to the bottom of the image. The “width” dimension can represent the number of columns in a 2D matrix or array. In images, it corresponds to the number of pixel columns from left to right. For instance, in a grayscale image with a width of 256 pixels, there are 256 columns of pixels from the left edge to the right edge. In the described implementation, the height dimension is given by number of rows 320 and the width is represented by the number of columns 322.

In one implementation, quantization simulation can be performed for the neural network post the training phase. During quantization simulation, activations and weight tensors are quantized for each layer of the neural network, such as layer 300, to deploy and perform inference of the neural network on hardware with limited precision. For instance, the quantization can be performed by changing weight tensors from a higher precision, such as 32 bit floating point (e.g., FP-32) to a reduced precision such as an integer value (e.g., INT-8 values). When such quantization occurs, it can be often necessary to dequantize the weight tensor value to restore it to its original precision for further analysis or visualization. Dequantization involves reversing the quantization process, e.g., by correction of quantization errors, and can help minimize the impact of rounding errors in post-processing. Further, quantization is simulated during the training process by introducing quantization functions that represent how the weight tensor will be quantized during inference. The quantization functions are used to estimate the impact of quantization on gradients during backpropagation. This helps the neural network adapt to the quantization effects.

In an implementation, quantization errors generated as a result of quantizing weight tensors are generally corrected during the training phase, retraining phase, and/or fine-tuning phase, so as to generate a lower precision neural network with acceptable levels of accuracy. However, these error correction techniques can be data intensive as they depend on the availability of training and/or calibration dataset, require multiple iterations, and consume additional computational resources during training, retraining, or fine-tuning, thereby affecting overall system memory bandwidth and efficiency. For instance, these techniques can be needed to regain model accuracy lost due to quantization of the weight tensor. Further, these processes can require additional training data to retrain and/or fine-tune the neural network, thereby making the error correction process data intensive. Furthermore, the process of correcting the quantization errors can be iterative, i.e., needs to be performed multiple times per layer in order to regain an acceptable level of accuracy, thereby becoming compute intensive and time consuming.

Frequently, the majority of processing tasks involved in implementing a neural network center around Matrix×Matrix, Matrix×Vector multiplications, convolution operations, or a combination of these operations. These operations are resource-intensive, demanding a significant amount of computational power and memory bandwidth. For instance, the matrices involved can be quite large, with dimensions like 1000×1000 elements or even larger. Each element is usually of Float or FP32 precision typically including various components, such as a sign, mantissa, and exponent.

In one implementation, in order to mitigate computational overheads and memory bandwidth bottlenecks associated with neural network computations at higher precision like float precisions, quantization of neural networks is performed to accelerate the inference and training process. Rather than using the traditional techniques of error correction for reducing the quantization error, which are data-driven, iterative and compute and memory intensive, a quantization circuitry (such as that described in FIG. 2) is configured to perform a data-free, non-iterative and efficient error correction process. Referring again to FIG. 3, the quantization circuitry is configured to perform an error computation 308 process, wherein error introduced at input channel 302 level is computed for each output channel 304, rather than computing error only at an output channel 304 (i.e., filter) level. This error is referred to as “quantization error.” In one example, the multiplication operations described above (e.g., multiply and accumulate or “MAC” operations) are carried out at an input channel 302 level, e.g., using quantized weight tensor values. The use of quantized weight tensor values introduces quantization errors, that have to be corrected to be within acceptable ranges before the neural network is processed further.

In an implementation, the quantization circuitry is configured to compute the quantization error at input channel 302 level, rather than computing the quantization error after the output of a MAC operation is generated. Since these MAC operations are performed at input channel 302 level, computing the quantization error for all output channels 304, as introduced at each of their respective input channels 302, can facilitate better accuracy, especially when the weight tensor is quantized in lower precision formats. In an implementation, error computation and weight tensor correction 308 can be performed in a data-free and non-iterative manner, e.g., post the training phase on the pre-trained weight tensors. For instance, rounding errors introduced during quantization operation for weights are determined to be greater than rounding errors introduced during quantization of activations for the layer 300. Based on this determination, the quantization circuitry can approximate the quantization error using error introduced only through weight tensor quantization and errors induced due to quantization of activations are disregarded. This way, the error computation and weight tensor correction 308 can be performed in a data-free manner since activations include the network's learned features or representations of the input data. Disregarding these representations of input data can therefore enable faster weight tensor correction and ensure that additional training data is not required at the time of weight correction during fine-tuning.

In an implementation, error computation and weight tensor correction 308 can be performed in a data-free and non-iterative manner post the training phase on the pre-trained weight tensors. For instance, rounding errors introduced during quantization operation for weights are determined to be greater than rounding errors introduced during quantization of activations for the layer 300. Based on this determination, the quantization circuitry can approximate the quantization error using error introduced only through weight tensor quantization and errors induced due to quantization of activations are disregarded. This way, the error computation and weight tensor correction 308 can be performed in a data-free manner since activations include the network's learned features or representations of the input data. Disregarding these representations of input data can therefore enable faster weight tensor correction and ensure that additional training data is not required at the time of weight correction during fine-tuning.

In one implementation, post computation of the quantization error, an error correction 310 is performed for the layer 300. According to the implementation, the error correction 310 is performed in a non-iterative manner. For example, the quantization error is normalized and corrected only once for the layer 300. In an implementation, for non-iterative correction, the quantization error is corrected using a correction factor. The correction factor is determined by the quantization circuitry, e.g., based on a total number of input channels 302 present in the layer 302. For example, if ‘I’ represents the total number of input channels 302 in the layer 300, the correction factor is determined by dividing the quantization error (determined using error correction 308) by the value of ‘I.’ This correction factor can then be used to singularly correct the quantization error for the layer 300. In one implementation, post computation of the quantization error, an error correction 310 is performed for the layer 300. According to the implementation, the error correction 310 is performed in a non-iterative manner. For example, the quantization error is normalized and corrected only once for the layer 300. In an implementation, for non-iterative correction, the quantization error is corrected using a correction factor. The correction factor is determined by the quantization circuitry, e.g., based on a total number of input channels 302 present in the layer 302. For example, if ‘I’ represents the total number of input channels 302 in the layer 300, the correction factor is determined by dividing the quantization error (determined using error correction 308) by the value of ‘I.’ This correction factor can then be used to singularly correct the quantization error for the layer 300.

In another implementation, a partial tensor correction 312 is performed for the layer 300, i.e., the weight tensor in higher precision is partially corrected using the correction factor. In traditional weight correction methods, the entire weight tensor is corrected by a specific correction factor. In an implementation, the partial tensor correction 312 is performed by computing the quantization error for all input channels and correcting that error for only a subset of input channels 302 for each output channel 304. That is, fewer than all of the input channels 302 are corrected for any given output channel 304. In one example, the portion corrected may be a predetermined portion (e.g., 10%, 25%) of otherwise. Other implementations are possible and are contemplated.

In one or more implementations, correcting the weight tensor partially can be efficient in reducing the quantization errors, since larger corrections are applied to partial tensors, rather than smaller corrections being applied to complete tensors. Further, the partial tensor correction can also be applied to data-driven error computation techniques, for improved accuracy, since this quantization scales, rounding schemes, or threshold-based clipping need not be modified, when quantizing weight tensors. In another implementation, error computation 308 is applied for every filter (i.e., every output channel 304), using quantization errors computed for all the input channels 302 in each filter. Using this quantization error, a subset of input channels 302 is corrected (error correction 310) and this correction is performed for all output channels 304 of the layer 300. As described in the foregoing, the correction can be performed for partial weight tensor value, e.g., using a correction factor determined using the number of total input channels 302 in the layer 300.

In one implementation, based on the partial correction of the weight tensor using the correction factor, the layer 300 is quantized to generate quantized layer 314, as shown. For each output channel 304, the subsets of input channels 302 for which weight tensors have been corrected are shown with shaded portions. It is noted that even though a single layer is described in FIG. 3, multiple layers can be corrected and quantized in a similar manner. Further, one or more processes, including but not limiting to, inference optimization, hardware deployment, performance evaluation, and the like can be performed after quantization of the layers of the neural network is complete.

Turning now to FIGS. 4A and 4B, block diagrams illustrating partial tensor retention are described. In one implementation, with heterogenous processing architectures, e.g., including a CPU and one or more accelerators or GPU working using a unified memory space as shown in FIG. 2, one or more convolutional or compute-intensive operations (like General Matrix Multiply functions) for a neural network can be offloaded for accelerator computations, while the CPU remains idle. Such computation models do not allow any such compute-intensive computations to be processed by a CPU. Further, in some situations, accelerators can only support instructions to execute compute-intensive operations of neural networks in lower precisions, to accelerate inference and training operations. Since all computations (for all layers) of the neural network are offloaded to accelerators, the neural network is typically executed using lower precision data (INT-4, INT-8). While such an approach may result in improved performance, overall accuracy may be reduced.

In methods and systems described with respect to FIG. 4A, capabilities of heterogenous processing architectures are exploited in order to accelerate performance for the neural network while maintaining an acceptable level of accuracy. As shown in the figure, a layer 400 for a neural network, e.g., a deep neural network (DNN), includes a given number of input channels 402 and output channels 404. Herein “output channels” refer to the depth or the number of features or filters used by the neural network layer 400 to process input data. Each output channel can represent a specific feature or pattern that the layer 400 can detect in the input data.

As described in the foregoing, quantizing contents of weight tensors can be performed to accelerate neural network's inference for improving performance and reducing overall memory usage. However, quantizing complete weight tensors from their original high precision formats to reduced precision formats, e.g., from FP32 format to INT-8 or INT-4 format, can achieve acceleration of neural network, albeit with high performance degradation. Therefore, parts of the weight tensor, corresponding to output channels 404 that are sensitive to quantization are retained in their original precision. Further, remaining channels 404 can be quantized. Retaining sensitive channels in original precisions and quantizing remaining channels can be beneficial for achieving acceleration for the neural network while maintaining acceptable levels of accuracy.

In one implementation, identification of output channels 404 that are sensitive to quantization can be performed in a data-free manner by computing a mean square error (MSE) that would result when quantizing a complete weight tensor 420 from a higher precision to a lower precision. For example, a quantization circuitry (e.g., quantization circuitry described in FIG. 2) can compute a per-channel scale for the weight tensor 420 and scale the weight tensor 420 using the per-channel scale. Further, this scaled tensor is rounded off to the nearest integer value and clipped to a given integer range to quantize the weight tensor 420. In order to compute the mean square error, first the quantized weight tensor is dequantized, e.g., using an inverse scale. The mean square error using the original precision weight tensor 420 and dequantized weight tensor is then computed. Based on the mean square error value being greater than or equal to a predefined threshold, output channels 404 that are sensitive to quantization are identified. These channels 404, and by extension their corresponding parts of the weight tensor 420, are not quantized, i.e., retained in their original precisions. In another implementation, identification of sensitive channels can further be done based on MSE and/or KL divergence in a data-driven manner. For instance, the MSE and/or KL Divergence error is computed between original and dequantized convolution outputs (i.e., multiply and accumulate operations) respectively. Based on a comparison of these outputs with predefined threshold, sensitive channels can be identified.

Based on this identification, a partial tensor retention 406 can be performed, such that for sensitive output channels 404, corresponding parts of the weight tensor 420 are retained in high precision, and for the remaining output channels 404, corresponding parts of the weight tensor 420 are quantized to lower precisions. For example, as shown in the figure, weight tensor parts 424 are retained in higher precisions, while weight tensor parts 422 are quantized to lower precisions. By association, output channels 404-A and 404-B are retained in higher precisions, and output channels 404-C to 404-N are quantized to lower precisions (as shown by shaded boxes). In an alternate implementation, sensitive channels 404 can also be quantized from their original precisions to another precision that is lower than the original precision but higher than precision used for the remaining non-sensitive channels. For example, the channels 404A and 404-B can be quantized from FP32 to BFloat16 or INT-8 precision (either precision processable by CPU) and 404-C to 404 -N are quantized to even lower precisions like INT-4 or INT-8 (processable by accelerator).

In an implementation, by retaining a subset of output channels 404 at a higher precision, higher level of flexibility for performance and accuracy can be realized, e.g., by offloading processing of these output channels 404 to a CPU 450 and executing the quantized output channels 404 at one or more accelerators 460. In one implementation, a fixed percentage, e.g., 25 percent of the output channels 404 can be retained in higher precisions and the remaining 75 percent output channels 404 can be quantized. Responsive to such a process, the number of output channels 404 offloaded to an accelerator 460 can be fewer than a number of channels previously assigned for the accelerator 460 for execution (e.g., when all output channels 404 are quantized). Further, since sensitive channels computations processed by CPU 450, improved performance and accuracy can be achieved. Other variations based on specific applications are possible and are contemplated.

In one implementation, varied quantization precision, i.e., different processing circuitries configured to execute neural network operations at different precision levels, can be leveraged to improve performance and accuracy by exploiting uniform memory access between these different processing circuitries. For example, CPU 450 and accelerators 460 like GPU or DPU could differ in quantization precisions. Taking advantage of these heterogenous capabilities, a predefined number of output channels 404 can be executed using CPU 450, e.g., in a specific supported format like FP32, BF16, or INT-8. Further, remaining output channels 404 can be executed on accelerators 460 in a quantized or lower precision format like INT4, INT-8, FP-16, or other block floating point formats.

In some situations, traditional quantization schemes for accelerators 460 can be based on power-of-2 quantization scales, as accelerators 460 can be configured to perform operations on this scale efficiently. Quantization using power-of-2 scale involves multiplying the weights with quantization scales that are power of 2 s. For example, instead of using a non-power of 2 scale value like 119.5, power of 2 quantization scale like 128 is used to quantize the weight to lower precisions like INT-8 Further, as CPU 450 can perform floating point operations efficiently, quantization scales for the CPU 450 can be set in floating-point format. In one implementation, using a power-of-2 scale for optimizing neural networks that are to be inferred by the CPU 450 can lead to sub-optimal accuracy. In order to mitigate these issues, different scale formats can be configured for CPU 450 and the accelerators 460. For example, part of the output channels 404, offloaded to an accelerator 460 can execute using a power-of-2 scale, and another part of the output channels 404 can be executed in a floating-point scale on CPU 450. Other combinations are possible and are contemplated. This heterogenous scale format can mitigate accuracy issues and lead to reduction in quantization noise for the layer 400.

In another implementation, separate rounding schemes can also be configured for the output channels 404 to be executed on the CPU 450 and those to be executed on the accelerators 460. Typically, the quantization operation involves rounding the scaled weights (of input channels 402, as described in FIG. 3) to the nearest integer value for INT quantization. However, simply rounding to the nearest value may not always be an adequate quantization mechanism with minimal quantization error, since other rounding schemes may work better, given the type of hardware that would be used to process the neural network. In one implementation, different devices in a heterogenous processing architecture, e.g., CPU 450 and accelerators 460, can make use of different rounding schemes during quantization of input channels 402, based on hardware capabilities of the device.

For example, for a first subset of input channels 402, quantization is done with a ceiling rounding scheme (i.e., round up to the next integer value) for the scaled weight values and for a second subset of input channels 402, quantization can be done with floor rounding scheme (i.e., round down to the previous integer value) for the scaled weight values. The first subset of input channels 402 can then be executed, for example, on the CPU 450. The second subset of input channels 402 can be executed using one or more accelerators 460. In one or more implementations, using such heterogenous rounding schemes, vectorized implementation for overall quantization rounding process without “if and else” branching can be performed, thereby eliminating branching operations and aiding in performance. One or more implementations combining heterogenous quantization and rounding schemes for partial tensor retention are contemplated.

Turning now to FIG. 4B, another block diagram illustrating partial tensor retention is described. The figure depicts a neural network layer 460 with ‘X’ number of output channels 468 (in the shown example, X=10 output channels). Each output channel 468 is associated with a weight tensor, from weight tensors 462-1 to 462-10, originally programmed using a given precision format. For instance, as shown in the figure, each weight tensor 462-1 to 462-10 has a precision level that is indicated using alphanumeric values. For example, originally all weight tensors 462 for all output channels 468 are programmed in a floating point (FP32) precision, i.e., in a high precision format.

In one implementation, based on the partial tensor retention mechanism described with regards to FIG. 4A, for a given number of the output channels 462 that are sensitive to quantization errors, weight tensors are retained in their original precisions. The remaining tensors are quantized to a lower precision, e.g., INT-8 precision. As shown, responsive to a partial tensor retention procedure 464, tensors 462-4 and 462-9 are identified as sensitive to quantization, and are therefore retained in their original FP32 formats. The remaining tensors, i.e., 462-1 to 462-3, 462-5 to 462-8 and 462-10 are quantized in a lower INT-8 precision format. In an implementation, the higher precision weight tensors can be executed using a CPU (e.g., CPU 450 of FIG. 4A) and lower precision weight tensors are executed using one or more accelerators (e.g., accelerators 462 of FIG. 4A).

In an implementation, spatial locality of the sensitive output channels 468 can be modified with one or more optimization techniques for performance gains. For example, output channels retained with higher precision weight tensors, i.e., tensors 462-4 and 462-9, are reordered (channel reordering 466) such that channels sensitive to quantization operation are contiguous and improve memory access latencies when accessed by different devices. As depicted, channels with weight tensors 462-9 and 462-4 have been reordered sequentially, and channel with weight tensor 462-10 is reordered to be contiguous with other lower precision channels. In another implementation, quantization noise can be further improved using partial fine-tuning, wherein only channels associated with FP32 weights are fine-tuned, whereas channels with the quantized weights remain unchanged. Traditional fine-tuning schemes may only follow one of: fine-tuning the weights for all the channels, or fine-tuning the weights of certain nodes while the rest of the weights are not modified. Partial tensor fine-tuning can further reduce the quantization noise thereby increasing model accuracy.

In an implementation, the proposed partial tensor retention methodology allows for exploiting heterogeneity across various processing devices, such as to achieve better utilization of idle times. Further, improved end to end accuracy with reduction in quantization noise is possible along with better performance by using multiple compute devices. In another implementation, the proposed methodology can be utilized with both data-free and data-driven techniques.

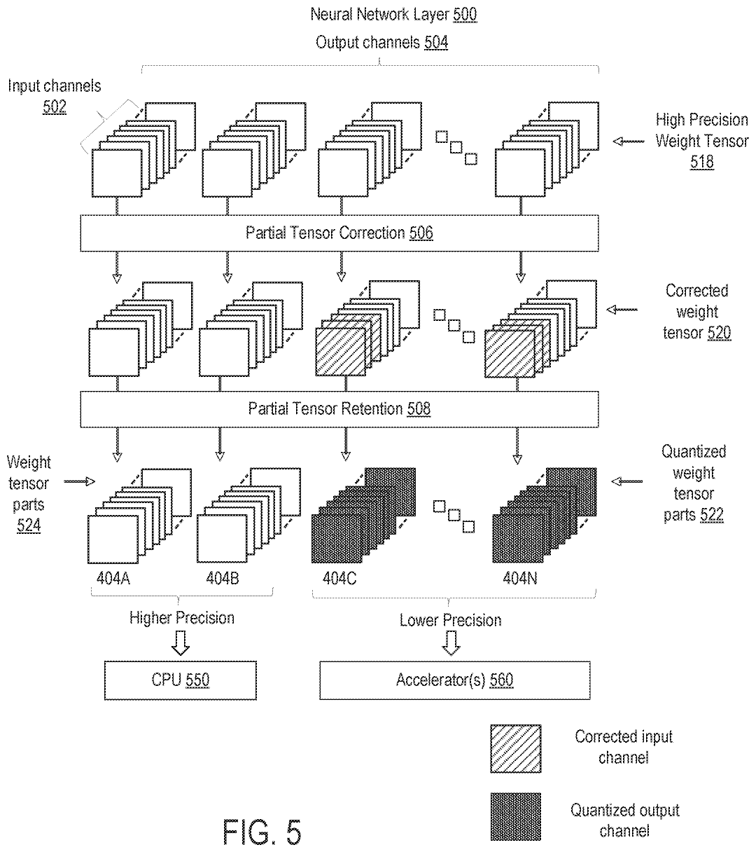

Turning now to FIG. 5, an exemplary block diagram illustrating partial tensor retention using partial tensor correction is described. As shown in the figure, a neural network layer 500 is made up of input channels 502 and resulting output channels 504. Further, the layer 500 is originally programmed with a high precision weight tensor 518, e.g., at a FP32 precision level. In one implementation, post the training phase, the pre-trained weight tensor 518 undergoes simulated quantization to the reduced precision of weight tensor in order to accelerate neural network inference 518, for improved model performance. Further, due to quantization simulation, quantization errors can be induced in output channels 504 affecting the model accuracy.

In an implementation, a quantization circuitry identifies one or more output channels 504 that are sensitive to quantization operation. In one example, sensitive channels 504 can be identified by computing a mean square error for that would resultant due to quantization of the weight tensor 518 from a higher precision to a lower precision. In operation, a per-channel scale for the weight tensor 518 is computed and the weight tensor 518 is scaled using the per-channel scale. Further, this scaled tensor is rounded off to its nearest integer value and clipped to a given integer range to quantize the weight tensor 518. In order to compute the mean square error, first the quantized weight tensor is dequantized, e.g., using an inverse scale. The mean square error resulting from the original precision weight tensor 518 and dequantized weight tensor is then computed. Based on the mean square error values that are greater than or equal to a predefined threshold, output channels 504 that are sensitive to quantization are identified. These channels 504, and by extension their corresponding parts of the weight tensor 518, are not quantized, i.e., retained in their original precisions.

As described with respect to FIG. 3, weight tensors can be corrected for quantization errors during training phase, in order to increase accuracy that is otherwise degraded as a result of quantization. In an implementation, partial corrections to the weight tensor can be applied, i.e., the weight tensor is partially corrected using computed error correction factor during quantization training. In one example, when the error is partially corrected for a weight tensor, the error correction factor becomes higher, and the probability of changes to the weight tensor can increase leading to reduction in quantization error and increased end to end model accuracy. In one implementation, the partial tensor correction 506 is performed such that the error is corrected for a subset of input channels 502 (shown by shaded boxes) for each output channel 504 that is identified as not being sensitive to quantization errors. That is, only a specific predetermined percentage of input channels 502 are corrected for any given output channel 504. In one example, the predetermined percentage is 25 percent. Other implementations are possible and are contemplated.

Based on identification of sensitive output channels 504, it is further determined which parts of the weight tensor 518 are to be retained for CPU computation and the remaining parts of the weight tensor 518 can be offloaded for accelerator computation. In an implementation, when parts of the weight tensor 518 identified for CPU computation are at higher FP32 precision formats, a partial tensor correction 506 is applied only to remaining parts of the weight tensor 518 that are to be offloaded to accelerators, i.e., parts of the tensor 518 that need to be executed at lower precisions (INT-4 or INT-8). In another implementation, when parts of the weight tensor 518 identified for CPU computation are at INT-8 precision and other parts of the tensor 518 identified for accelerator computation are at INT-4 precision, a partial tensor correction 506 is applied to both parts of the weight tensor 518, since this can improve accuracy of weight tensor parts in both INT-8 and INT-4 precisions. That is, weight tensor correction is applied only to output channels 504 that are to be processed at lower precisions, either using CPU or accelerators.

In one implementation, using the partial tensor correction 506, the quantization error is partially corrected for the weight tensor 518. That is, partial tensor correction 506 is performed such that quantization error is corrected for a subset of input channels 502 for output channels 504 that are not identified as sensitive to quantization errors. For example, the weight tensor 518 is partially corrected only for a predetermined percentage of input channels 502 for a given output channel 504 that is identified as non-sensitive to quantization error. As shown, partial tensor correction 506 is performed for output channels 504C-504N, such that weight tensor 518 is partially corrected (to generate corrected weight tensor 520) for a subset of input channels 504, for each output channel 504C-504N. These input channels are shown using shaded boxes. The weight tensor parts corresponding to remaining output channels 504A and 504B remain unmodified.

In one implementation, based on error corrections for output channels 504 that are not sensitive to quantization, a partial tensor retention function 508 is performed, wherein a predefined percentage of the output channels 504 are retained in higher precisions. These sensitive channels 504 can be retained in FP32 precision formats or alternatively can also be retained in low precisions like INT-8. The remaining output channels 504, i.e., 75 percent of channels, are quantized to lower precisions like INT-4 or INT-8 (as shown by shaded boxes). Further, higher precision output channels 504 can be offloaded to CPU 550 for computations, whereas the remaining lower precision output channels 504 are queued for one or more accelerators 560 for processing. In an implementation, by applying partial tensor correction to correct parts of weight tensor only for output channels not sensitive to quantization, along with partial tensor retention for sensitive output channels, enables better model accuracy and better performance using heterogenous processing capabilities of both the CPU and accelerators.

Turning now to FIG. 6, an exemplary method illustrating partial tensor correction is described. In one implementation, a neural network layer comprises of input channels and output channels. Further, the layer is made up of specific number of dimensions including, e.g., the input channels, the output channels, height of the layer and width of the layer. In one implementation, post the training phase or during a training/retraining phase, quantization simulation can be performed for the neural network. During quantization simulation, weight tensors are received in higher precision (block 602), such that the weight tensors can be simulated for quantization for each layer of the neural network. In one example, the weight tensor can be quantized post the training phase with the pre-trained weight tensors or during training/retraining phase to train the neural network for deployment on hardware with limited precision, e.g., in order to increase computational efficiency when performing different operations for the neural network. For instance, quantization can be performed by changing weight tensors from a higher precision, such as FP32, to a reduced precision such as an integer value (e.g., INT-8 values). Quantization can induce errors in the weight tensors that need to be corrected before deployment and inference.

In an implementation, quantization errors generated as a result of quantizing weight tensors are generally corrected post the training phase or during a training and/or retraining phase, to generate a lower precision neural network with acceptable levels of accuracy. In order to correct the quantization error generated due to quantization of weights, a quantization circuitry (such as that described in FIG. 2) is configured to compute the quantization error (block 604). In one example, the quantization error is computed as induced at input channel level, rather than computing error only at an output channel (i.e., filter) level. For example, multiplication operations such as multiply and accumulate or “MAC” operations are carried out at an input channel, can induce error when performed using quantized weight tensor. This error must be corrected to be within acceptable ranges before the neural network is processed further. Therefore, the quantization circuitry is configured to compute the quantization error at input channel level, since these MAC operations are performed at input channel level and computing the quantization error at respective input channels can facilitate better accuracy. In an implementation, weight tensor correction is performed in a data-free and non-iterative manner on the pre-trained weights post the training phase, by approximating the quantization error using error introduced only through weight tensor quantization, while disregarding errors induced due to quantization of activations. In another implementation, error computation and weight tensor correction is performed after the forward pass during back propagation phase of training.

In one implementation, based on the quantization error, an error correction factor is generated (block 606). The error correction using the correction factor can be performed in a non-iterative manner. For example, the quantization error is normalized and corrected only once per layer. In an implementation, for non-iterative correction, the correction factor is determined based on a total number of input channels present in a layer. For example, if ‘n’ represents the total number of input channels for a layer, the correction factor is determined by dividing the quantization error by the value of ‘n.’ This correction factor can then be used to singularly correct the quantization error for the layer. Other implementations are contemplated.

Further, the weight tensor is corrected using the correction factor (block 608). In an implementation, a partial tensor correction is performed, i.e., weight tensor in higher precision is partially corrected using the correction factor, to generate weight tensor in lower precision. In traditional weight correction methods, the entire weight tensor is corrected by a specific correction factor. However, when quantization error is corrected for the entire weight tensor, the probability of changes or updates to the weight tensor decreases. In contrast, when the quantization error is computed for all the input channels and that error is used to partially correct the weight tensor, the error correction factor becomes higher, and the probability of changes to weight tensor can increase leading to reduction in quantization error and improved model accuracy. In an implementation, the partial tensor correction is performed such that quantization error is computed for all the input channels and that error is corrected for a subset of input channels for a given output channel. That is, only a specific predetermined percentage of input channels are corrected for any given output channel.

In one implementation, based on the partial corrections to weight tensors per-layer, using the correction factor, the neural network weights are corrected. The corrected weights are then quantized from higher precision to low precision formats (block 610), e.g., INT-4, INT-8, etc. The quantized network can then be processed further using processing circuitry, such as a CPU or a GPU (block 612). These further processes can include inference optimization, hardware deployment, performance evaluation, and the like.

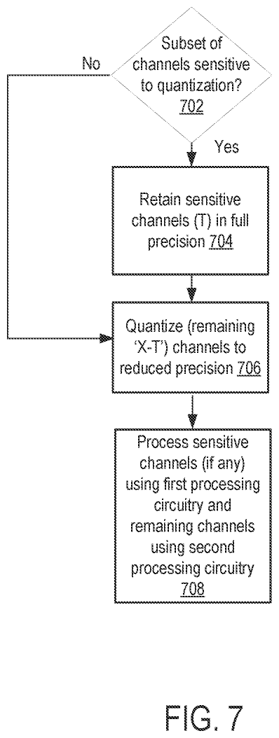

Turning now to FIG. 7, an exemplary method illustrating partial tensor retention is described. In an implementation, quantizing contents of pre-trained weight tensors can be performed to accelerate neural network's inference for improving performance and reducing overall memory usage. However, quantizing complete weight tensors from their original high precision formats to reduced precision formats, e.g., from FP32 format to INT-8 or INT-4 format, can achieve acceleration of neural network, but can incur high accuracy degradation. Therefore, retaining parts of the weight tensor, corresponding to output channels that are sensitive to quantization, in their original precision, while quantizing the remaining tensor parts can be beneficial for achieving acceleration for the neural network while maintaining acceptable levels of accuracy.

In one implementation it is determined whether one or more output channels are sensitive to quantization, i.e., channels for which accuracy is not within acceptable limit when quantized (conditional block 702). In one implementation, identification of output channels that are sensitive to quantization can be performed by computing a mean square error that would result when quantizing a complete weight tensor 420 from a higher precision to a lower precision. In order to compute the mean square error, first the quantized weight tensor is dequantized, e.g., using an inverse scale. The mean square error of original precision weight tensor 420 and dequantized weight tensor is then computed. Based on the mean square error values that are greater than or equal to a predefined threshold, output channels 404 that are sensitive to quantization are identified. If no sensitive output channels are identified (conditional block 702, “no” leg), the method moves to block 706.

However, if sensitive output channels are identified (conditional block 702, “yes” leg), a partial tensor retention is performed, such that for sensitive output channels, corresponding parts of the weight tensor are retained in high precision (block 704). Further, for remaining output channels, corresponding weight tensor parts are quantized to lower precisions (block 706). By association, sensitive output channels are retained in higher precisions, and remaining output channels are quantized to lower precisions. If no sensitive channels are identified, all output channels can be quantized to lower precisions.

In an implementation, by retaining a subset of output channels at a higher precision, higher level of flexibility for performance and accuracy can be realized, e.g., by offloading processing of these output channels to a first processing circuitry, such as a CPU and executing the quantized output channels using second processing circuitry, e.g., one or more accelerators (block 708). In one implementation, a fixed percentage, e.g., 25 percent of the output channels can be retained in higher precisions and the remaining 75 percent output channels can be quantized. The number of output channels executed on accelerators can be lesser than a number of channels previously assigned to the accelerators for execution (e.g., if all output channels are quantized). Further, since sensitive channels computations are offloaded to a CPU, improved performance and accuracy can be achieved. Other variations based on specific applications are possible and are contemplated.

In one implementation, varied quantization precision, i.e., different processing circuitries configured to execute neural network operations at different precision levels, can be leveraged to improve performance and accuracy by exploiting uniform memory access between these different processing circuitries. For example, CPU and accelerators like GPU or DPU, could differ in quantization precisions. Taking advantage of these heterogenous capabilities, a predefined number of output channels can be executed using the CPU. Further, remaining output channels can be executed on accelerators.

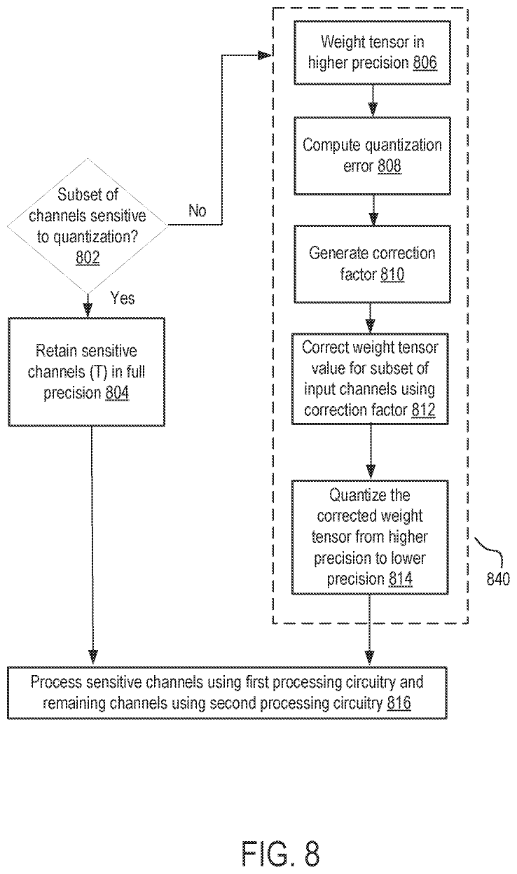

Turning now to FIG. 8, an exemplary method illustrating partial tensor correction with partial tensor retention is described. In an implementation, it is determined whether one or more output channels are sensitive to quantization, i.e., channels for which accuracy is not within acceptable limit when quantized (conditional block 802). In one implementation, identification of output channels that are sensitive to quantization can be performed in a data-free manner by computing a mean square error that would result when quantizing a complete weight tensor from a higher precision to a lower precision. In another implementation, identification of output channels that are sensitive to quantization can be performed in a data-driven manner by computing either KL Divergence of original and dequantized convolution outputs of layers or by computing the MSE of original and dequantized convolution outputs of layers. If sensitive output channels are identified (conditional block 802, “yes” leg), a partial tensor retention is performed, such that for identified sensitive output channels, corresponding parts of the weight tensor are retained in high precision (block 804). If no sensitive output channels are identified (conditional block 802, “no” leg), the method moves to the flowchart 840.

In one implementation, post the training phase or during a training/retraining phase, quantization simulation can be performed for the neural network. As shown in the flowchart 840, during quantization simulation, weight tensors are received in higher precision (block 806), such that the weight tensors can be simulated for quantization for each layer of the neural network. In one implementation, if a specified number of output channels are identified as sensitive to quantization, weight tensor parts are quantized to lower precisions only for remaining output channels. That is, sensitive output channels are retained in higher precisions, and remaining output channels are quantized to lower precisions.

For these non-sensitive channels under quantization simulation, a quantization error is computed (block 808). In one example, the quantization error is computed as induced at input channel level, e.g., due to multiplication operations carried out at an input channel. In an implementation, error computation and weight tensor correction can be performed in a data-free and non-iterative manner post the training phase on the pre-trained weight tensors by approximating the quantization error using error introduced only through weight tensor quantization while disregarding errors induced due to resulting quantization of activations. In another implementation, error computation and weight tensor correction is performed after the forward pass during back propagation phase of training.

In one implementation, based on the quantization error, an error correction factor is generated (block 810). Further, the weight tensor is corrected using the error correction factor (block 812). The error correction using the generated error correction factor can be performed in a non-iterative manner. For example, the quantization error is normalized and corrected only once per layer. In an implementation, for non-iterative correction, the correction factor is determined based on a total number of input channels present in a layer. For example, if ‘n’ represents the total number of input channels for a layer, the correction factor is determined by dividing the quantization error by the value of ‘n.’ This correction factor can then be used to singularly correct the quantization error for the layer. Other implementations are contemplated.

In an implementation, a partial tensor correction is performed, i.e., weight tensor in higher precision is partially corrected using higher correction factor, in order to ensure that probability of changes to weight tensor can increase leading to reduction in quantization error and improvement in model accuracy. The corrected weight tensor in higher precision is then quantized to lower precision (block 814). In an implementation, the partial tensor correction is performed such that quantization error is computed for all input channels and that error is corrected for a subset (fewer than all) of input channels for a given output channel. In one implementation, based on the partial corrections to weight tensors per-layer, using the correction factor, the neural network is quantized.

In an implementation, by retaining a subset of output channels at a higher precision, higher level of flexibility for performance and accuracy can be realized, e.g., by offloading processing of these output channels to a first processing circuitry, such as a CPU and executing the quantized output channels using second processing circuitry, e.g., one or more accelerators (block 816). In one implementation, a fixed percentage of the output channels can be retained in higher precisions and the remaining output channels can be quantized.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A processor comprising:
quantization circuitry configured to:
compute an error introduced into each of a plurality of input channels of a given layer of a neural network, responsive to quantizing weight tensor values; and
for each output channel, correct the weight tensor values for only a subset of input channels of the plurality of input channels based on the error.

2. The processor as claimed in claim 1, wherein a correction factor applied to the weight tensor values is calculated at least in part by dividing the error by a total of the plurality of input channels.

3. The processor as claimed in claim 2, wherein the weight tensor values for the subset of input channels are corrected using the correction factor.

4. The processor as claimed in claim 1, wherein the error is introduced at an input-channel level, responsive to one or more multiply and accumulate operations performed for each input channel of the plurality of input channels.

5. The processor as claimed in claim 1, wherein the error is computed based at least in part on one or more rounding errors introduced in the weight tensor value responsive to the quantization.

6. The processor as claimed in claim 1, wherein the weight tensor values are corrected using the computed error once per layer for each given layer of the neural network.

7. The processor as claimed in claim 1, wherein quantizing the weight tensor values comprising changing a precision of a weight tensor values from a first precision to a a lower second precision.

8. A method comprising:
computing an error introduced into each of a plurality of input channels of a given layer of a neural network, responsive to quantizing weight tensor values; and
correcting, for each output channel, the weight tensor values for only a subset of input channels of the plurality of input channels based on the error.

9. The method as claimed in claim 8, further comprising applying a correction factor to the weight tensor values calculated at least in part by dividing the error by a total of the plurality of input channels.

10. The method as claimed in claim 9, wherein the weight tensor values for the subset of input channels are corrected using the correction factor.

11. The method as claimed in claim 8, wherein the error is introduced at an input-channel level, responsive to one or more multiply and accumulate operations performed for each input channel of the plurality of input channels.

12. The method as claimed in claim 8, wherein the error is computed based at least in part on one or more rounding errors introduced in the weight tensor value responsive to the quantization.

13. The method as claimed in claim 8, wherein the weight tensor value is corrected using the error once per layer for each given layer of the neural network.

14. The method as claimed in claim 8, wherein quantizing the weight tensor values comprises changing a precision of a weight tensor value from a first precision to a lower second precision.

15. A system comprising:
a processing circuitry; and
quantization circuitry configured to:
quantize, for a given layer of a neural network, an associated weight tensor value, from a first precision to a reduced second precision, the given layer comprising a plurality of input channels and a plurality of output channels;
compute an error introduced in each of the plurality of input channels of the given layer responsive to the quantization; and
for each output channel, correct the weight tensor for a subset of input channels from the plurality of input channels using the computed error.

16. The system as claimed in claim 15, wherein the weight tensor value is corrected for the subset of input channels using a correction factor associated with the computed error, the correction factor at least in part calculated by dividing the computed error with a total number of input channels of the plurality of input channels.

17. The system as claimed in claim 16, wherein the weight tensor value is partially corrected using the correction factor.

18. The system as claimed in claim 15, wherein the error is introduced at an input-channel level, responsive to one or more multiply and accumulate operations performed for each input channel of the plurality of input channels.

19. The system as claimed in claim 15, wherein the error is computed based at least in part on one or more rounding errors introduced in the weight tensor value responsive to the quantization.

20. The system as claimed in claim 15, wherein the weight tensor value is corrected using the error once per layer for each given layer of the neural network.
